(19) United States
(12) Patent Application Publication
(10) Pub. No.: US 2011/0315420 A1
(43) Pub. Date: Dec. 29, 2011

(54) Cable Boot and Clamp Cable Mounting System

(76) Inventor: Kevin B. Larkin, Pebble Beach, CA (US)

(21) Appl. No.: 12/825,399

(22) Filed: Jun. 29, 2010

(51) Int. Cl. H02G 7/14; B23P 19/00; H01B 7/00

(52) U.S. Cl. 174/42; 174/135; 29/700

(57) ABSTRACT

A soft cable boot is snapped on or molded around a cable or cable harness. The cable boot has a three dimensional interlock structure on its circumference via which it interlocks with an interlock teeth profile of a boot clamp. While the boot clamp is mounted and tied down, the interlock teeth profile is pressed into the three dimensional interlock structure and the cable or cable harness is three dimensionally form fitting and elastically fixed, whereby vibration related cable wear is reduced. A boot assembly tool may be used to snap the cable boot onto the cable and/or to inject a sealant into the assembled boot clamp or mold the boot clamp around the cable.

### CROSS REFERENCE

The present invention cross references US patent application of the same inventor titled “Cable Constraining Device For Reduced Cable Wear”, application Ser. No. 12/131,096, filed 1 Jun. 2008 and US Continuation in Part patent application of the same inventor, titled “Cable Constraining Device For Reduced Cable Wear”, application Ser. No. 12/200,904, filed 28 Aug. 2008, both of which are herewith incorporated by reference.

### FIELD OF INVENTION

The present invention relates to cable fixture and clamping systems. In particular, the present invention relates to cable fixture and clamping systems employing an elastic cable boot in a three dimensionally formfitting interlock with a mounting clamp.

### BACKGROUND OF INVENTION

In motorized vehicles such as aircrafts, cables and cable strands are commonly exposed to substantial vibrations. Such vibrations may be transferred onto the entire cable or cable strand at their mounting sites as three dimensional linear and rotational micro movements that may excite the unsupported portions of the cable or cable strand in between their adjacent mounting sites. This commonly causes wear of the cable insulation at the mounting interface where the cable or cable strand is fixedly held. Therefore, there exists a need for a cable or cable strand mounting system that minimizes micro movements and that dampens vibrations in the mounting interface while at the same time providing a solid three dimensional fix of the cable or cable strand. The present invention addresses this need.

Another common cause for cable wear or deterioration of the cable insulation is dust, debris and/or moisture creeping into the mounting interface. Therefore, there exists a need for a sealed cable or cable strand mounting interface. The present invention addresses also this need.

### SUMMARY OF INVENTION

A cable clamp system features a cable boot with a cable through hole and a peripheral three axes interlock structure that engages with a correspondingly shaped interlock teeth profile of a boot clamp. The boot clamp encompasses the cable boot and features a mounting interface via which both the boot and the clamp may be mounted. The cable boot is of relatively soft material and tapers out towards its two opposing ends to provide a gradual stiffness decline towards its two respective opposing ends. In that way, cable movement of the freely suspended cable extending from the cable boot is transferred onto the boot with minimized friction between the cable and the boot at its two opposing ends. Particularly for aviation cable strands that are exposed to strong vibrations, the cable clamp system of the present invention may reduce wear and insulation cracking in the transition between the fixed and freely suspended portions of the cable or cable strand. The interlock teeth profile may further feature a damping configuration as described in the cross referenced applications to dampen vibrations transmitted from the cable or cable strand onto the cable boot.

A cable boot assembly tool may be part of the system, featuring a separable boot cavity within which an open cable boot may be placed and snap closed around the cable or cable harness. The cable boot assembly tool may further feature an injection molding device to inject mold material such as thermosetting plastic or resin into the boot clamp to seal and/or snugly encapsulate the cable or cable strand inside the boot clamp. Alternately, the boot clamp itself may be formed by injection molding around a portion of the cable or cable strand that is held inside the boot cavity.

The dual system of a flexible boot and a frame supported clamp provides a firm mounting and at the same time a soft but three dimensionally stable positioning of the cable or cable strand. Vibrations and wear of the cable or cable harness are opposed and minimized. The sealed fix of the cable or cable strand inside the cable boot keeps dust, debris or moisture away, which may also contribute to an extended lifespan of the cable insulation inside the cable boot.

### BRIEF DESCRIPTION OF THE FIGURES

FIG. 1 is a first perspective view of a first embodiment of the invention assembled around a cable strand.

FIG. 2 is a second perspective view of the embodiment of FIG. 1.

FIG. 3 is the second perspective view of the embodiment of FIG. 1 cut along a radial symmetry plane.

FIG. 4 is a third perspective view of the cable boot of FIG. 1.

FIG. 5 is the third perspective view of a cable boot according to a second embodiment of the invention partially assembled on a cable strand.

FIG. 6 is the third perspective view of a first embodiment of a cable boot assembly tool of the present invention in opened position around a cable boot and cable harness.

FIG. 7 is the third perspective view of a second embodiment of a cable boot assembly tool having an injection molding device. The cable boot assembly tool is closed around a cable strand.

FIG. 8 is the third perspective view of the second embodiment of the cable boot assembly tool of FIG. 7, a cable strand and a cable boot, all cut along a radial symmetry plane.

FIG. 9 is the third perspective cut view of the cable boot and cable harness of FIG. 8 with injected mold material.

FIG. 10 is the third perspective cut view as FIG. 8 without cable boot in the boot cavity.

FIG. 11 is the third perspective cut view of a cable boot monolithically molded around the cable strand in accordance to FIG. 10.

### DETAILED DESCRIPTION

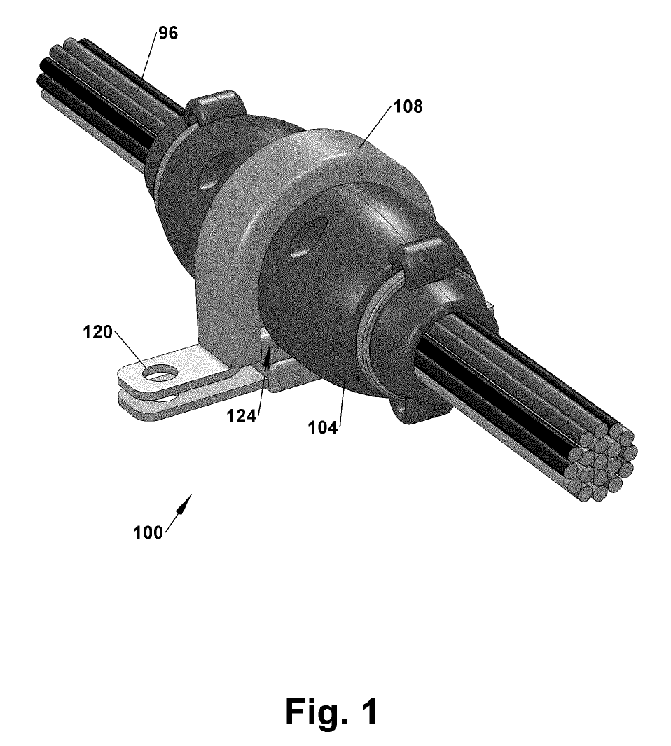

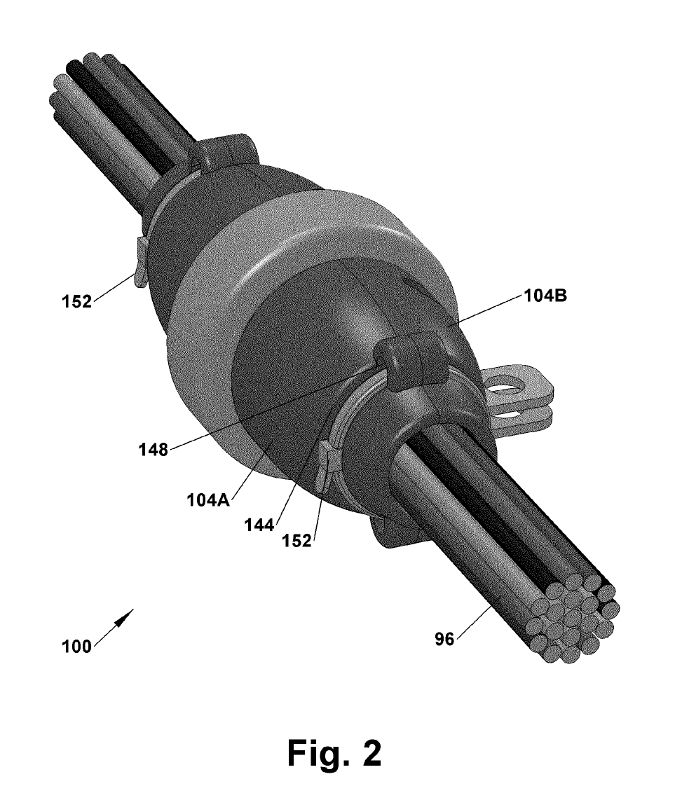

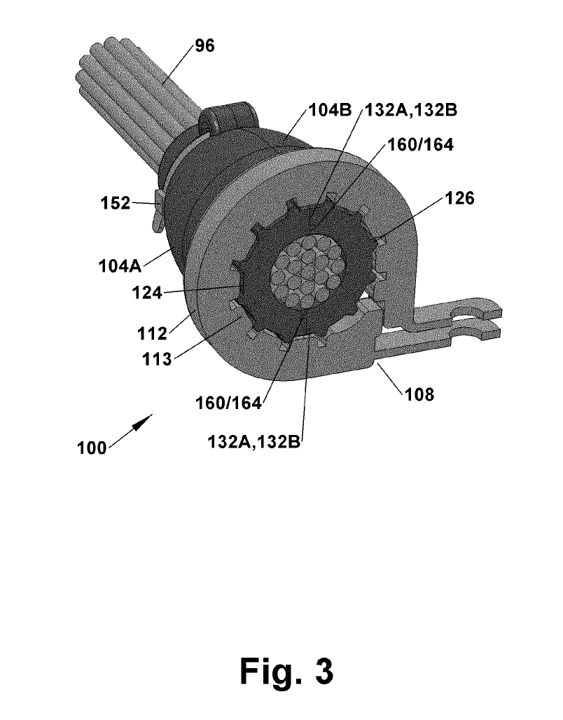

Referring to FIGS. 1-4, a cable clamp system 100 according to a first embodiment of the invention features a cable boot 104 and a boot clamp 108. The cable boot 104 has a cable through hole 128 configured to fixedly hold a cable or cable strand 96. The cable boot 104 has also on its periphery a three axes interlock structure 124 including a circumferential groove 125 and at least one but preferably a number of axial ribs 126 that are inside the circumferential groove 125. The peripheral three axes interlock structure 124 encompasses the cable through hole 128. The boot clamp 104 features an interlock teeth profile 112, a clamp frame 116 that is circumferentially connected to the interlock teeth profile 112 and a clamp mounting interface 120. The interlock teeth profile 112 may have vibration damping configuration as described in the cross referenced applications. The interlock teeth profile 112 matches the peripheral three axes interlock structure 124 while the cable boot 104 is clamped in the boot clamp 108. The clamping of the cable boot 104 in the boot clamp 108 and a three axes interlock between them is established by use of a clamping segmentation of the clamp frame 116 such that while the boot clamp 108 is tied down via the clamp mounting interface 120, the interlock teeth profile 112 is forced towards the peripheral three axes interlock structure 124.

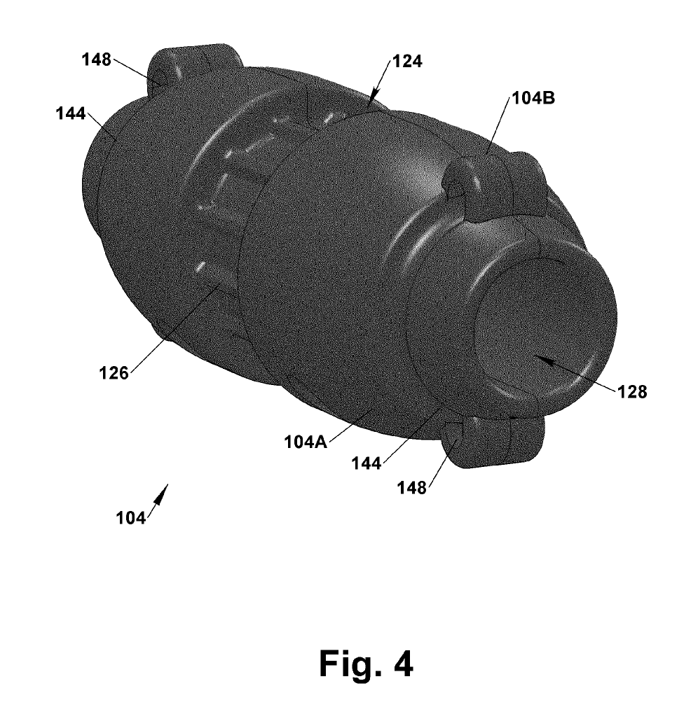

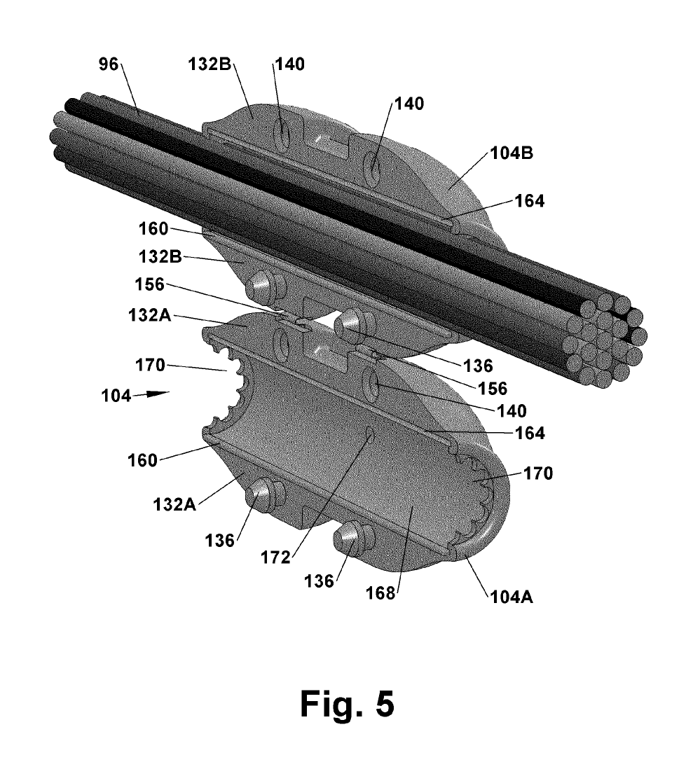

Referencing also to FIGS. 4, 5, the cable boot 104 may include preferably two body segments 104A, 104B, each featuring a mating face 132A/132B. Each one of the mating faces 132A/132B is extending substantially radially outward from the cable through hole 128 and facing an opposite one other of the mating face 132B/132A while the boot clamp is assembled. In that way, the cable through hole 128 is circumferentially open while the body segments 104A, 104B are apart and a cable or cable strand 96 may be conveniently inserted as shown in FIG. 5. When the two body segments 104A, 104B are assembled together around the cable or cable strand 96, the cable or cable strand 96 is preferably fully encapsulated inside the cable through hole 128.

The mating faces 132A, 132B have one of a snap stud 136 and a snap hole 140 via which the body segments 104A, 104B may be snapped together while the mating faces 132A, 132B are in contact and while the cable through hole 128 is circumferentially closed. The cable boot 104 may also feature circumferential tie guide holes 148 and at least one but preferably two circumferential tie grooves 144 that extend circumferentially across the mating faces 132A, 132B while the two body segments 104A, 104B are snapped together. The circumferential tie grooves 144 and tie holes 148 are preferably in the vicinity of the openings of the cable through hole 128 to hold optional boot ties 152 axially in position. The boot ties 152 may be wrapped around and tying together the body segments 104A, 104B in addition or alternating to the snap studs 136 and snap holes 140 to firmly hold the body segments 104A, 104B together.

As depicted in FIG. 5, one or more flexible film joints 156 may be employed that connect rotationally free the body segments 104A, 104B, with each other. In that way, they may assist the handling of the two body segments 104A, 104B during their assembly around the cable or cable strand 96. Also by employing the flexible film joints 156, the body segments 104A, 104B may be monolithically fabricated by well known injection molding techniques.

To oppose dust, debris or moisture from entering the eventual gaps between individual strands of the cable strand 96 and/or in between the cable or cable strand 96 and the cable through hole 128, following features may be employed either alone or in combination with each other as may be well appreciated by anyone skilled in the art. To seal any eventual gap between opposing mating faces 132A, 132B radially towards the cable through hole 128, seal ridges 160 and seal valleys 164 may be positioned along an edge between a portion of the cable through hole 128 and one of the mating faces 132A, 132B as shown in FIG. 5. To seal the openings of the through holes 128 particularly in case of a held cable strand 96, radial seal ribs 170 may extend substantially radially inward the cable through hole 128. The radial seal ribs 170 may correspond to the circumferential contours of the cable strands 96 for a snug sealing contact as may be well appreciated by anyone skilled in the art. The radial seal ribs 170 may also assist in fixedly holding individual strands of the cable 96 thereby particularly contributing to minimizing vibration related micro-friction and wear of the cable strand's 96 insulation.

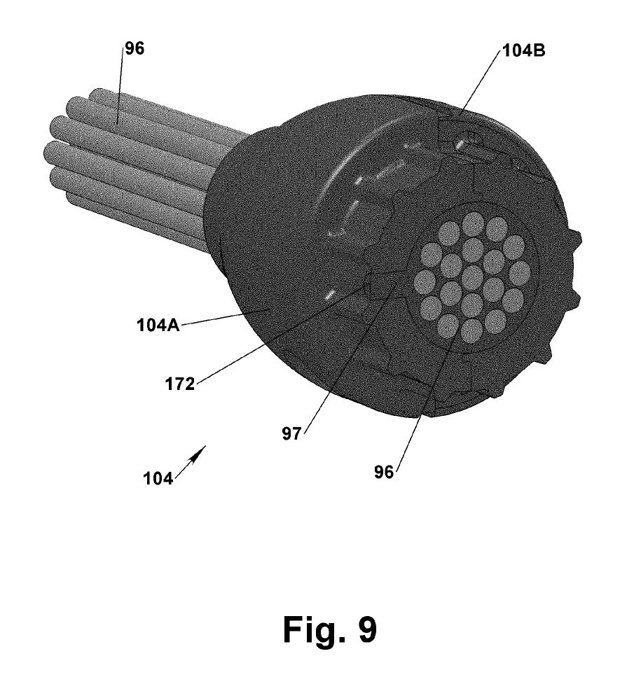

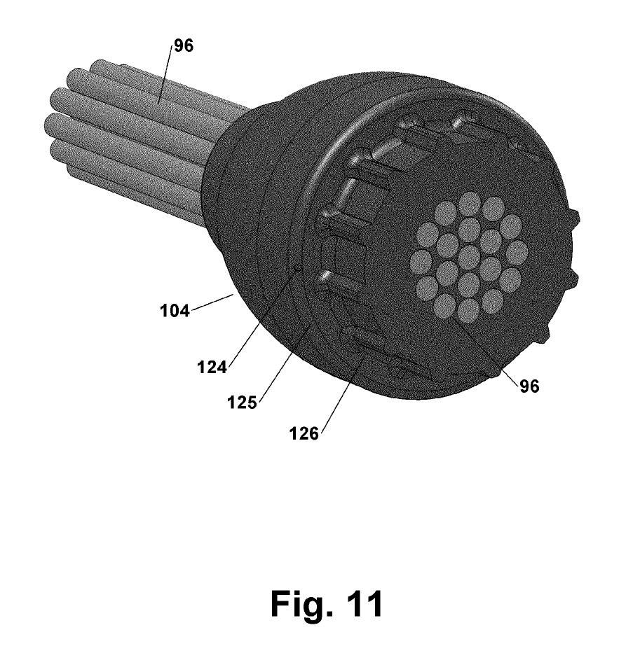

A snug fix, good sealing and eventual adhesive connection of the cable or cable strand 96 inside the cable boot 104 may also be accomplished by providing the cable boot 104 with an internal sealant distribution cavity 168 and a peripheral sealant access port 172 that is in communication with the internal sealant distribution cavity 168. The internal sealant cavity 168 extends radial outward the cable through hole 96 and axially in between both cable through hole 96 openings. It may receive a fluid sealant via the peripheral sealant access port 172 while the clamp boot 104 is assembled around the cable or cable strand 96 as depicted in FIG. 9. The sealant may cure once distributed. Alternately, the entire boot clamp 104 may be molded around the cable or cable strand 96 as depicted in FIG. 11.

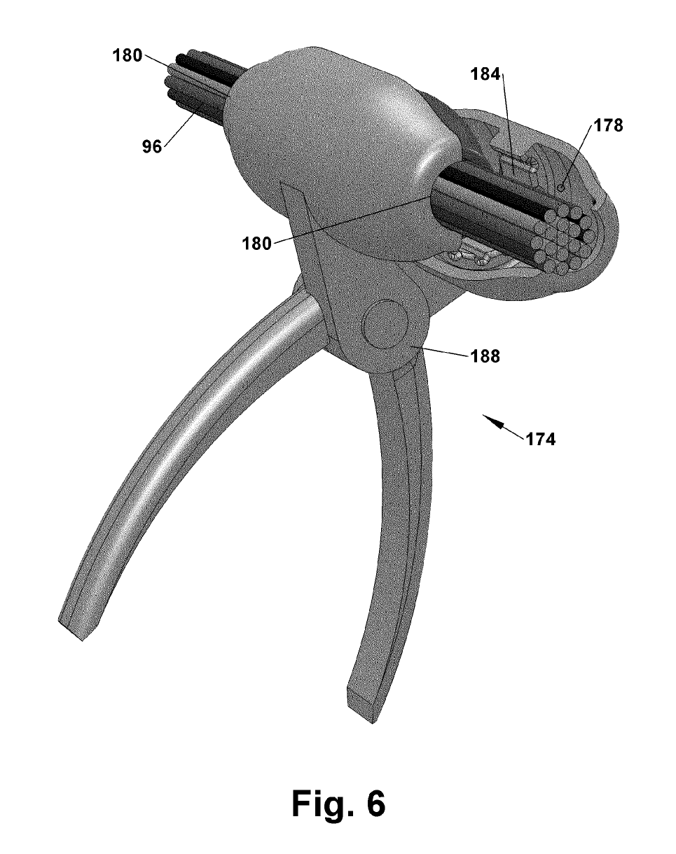

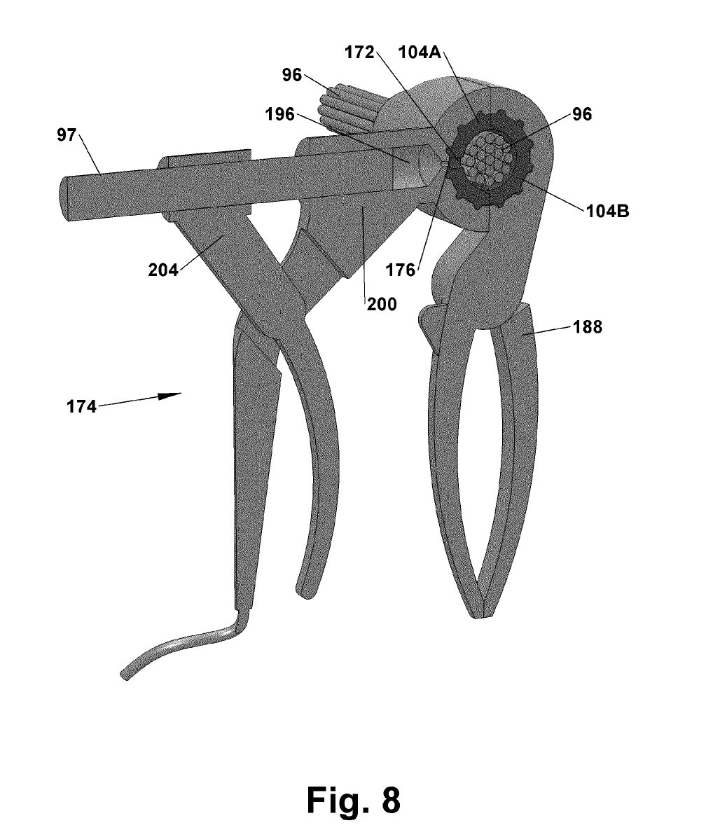

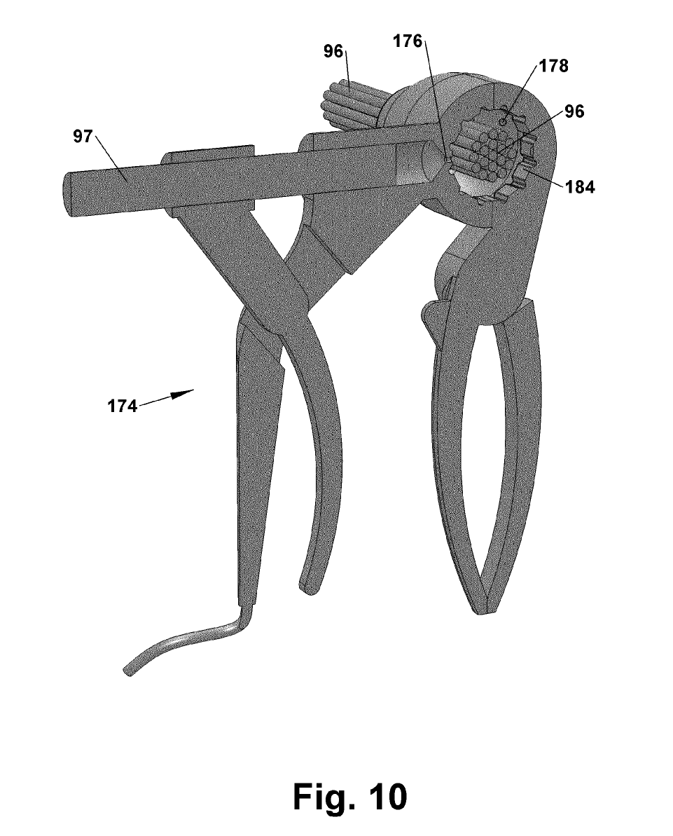

Snapping together of the body segments 104A, 104B, and/or sealant injection and/or cable boot 104 molding may be accomplished by a cable boot assembly tool 174 as depicted in FIGS. 6-8, 10. According to FIG. 6, a basic configuration of the cable boot assembly tool 174 features cable alignment openings 180, a separable boot cavity 178, and a hand operable cavity open and close mechanism 188. The separable boot cavity 178 has a three axes interlock structure negative shape and is shaped with respect to the cable alignment openings 180 such that a substantially continuous cable boot negative shape including a three axes interlock structure negative shape is defined around the cable or cable strand 96 held in the cable alignment openings 180 while the cable boot assembly tool is closed around the cable or cable strand 96. In that way the body segments 104A, 104B may be snugly fitted into the cable boot assembly tool 174 such that irrespective a softness of the body segments 104A, 104B of about . . . (Please provide an targeted Shore hardness), the body segments 104A, 104B may be firmly snapped together.

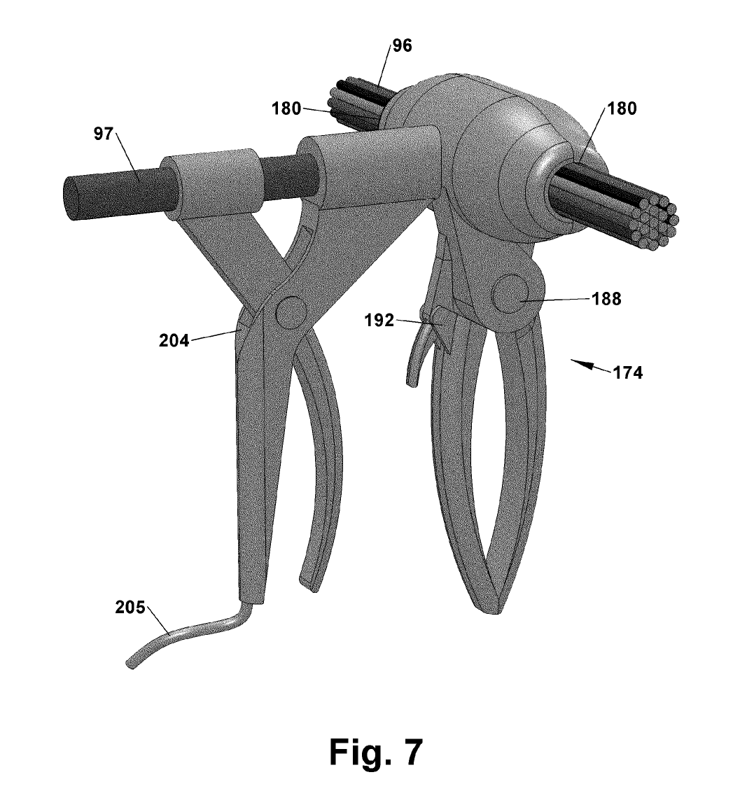

In an alternate embodiment depicted in FIGS. 7, 8, 10, the cable boot assembly tool 174 features also an injection port 176, a release able closing ratchet 192 as part of the hand operable cavity open and close mechanism 188, a molding material storage cavity 196, an optional storage cavity heater 200 in case of a thermosetting sealant or molding material, and an injection mechanism 204 that is preferably manually operable.

The cable boot 104 may be initially assembled on a predetermined position along the cable or cable strand 96 by snapping on the two body segments 104A, 104B followed by an optional additional tightening with boot ties 152. To snap the two body segments 104A, 104B together, the cable tool assembly tool 174 may be employed. After the cable boot 104 is assembled on the cable or cable strand 96 and in the embodiment where an internal sealant distribution cavity 168 and a peripheral sealant access port 172 are provided by the cable boot 104, sealant may be injected into the cable through hole 128 via the cable boot assembly tool 174.

In case the cable boot 104 is molded directly on a predetermined location of the cable or cable strand 96, the boot cavity 178 may tied around the cable or cable strand 96 at that predetermined location and the optional release able closing ratchet 192 may be set to hold the boot cavity 178 closed while mold material 97 is injected into the boot cavity 178 around the cable or cable strand 96. Once the mold material 97 has sufficiently cooled down or cured to hold its shape, the closing ratchet 192 may be released and the cable boot assembly tool 174 removed.

Once the cable boot 104 is assembled on the cable or cable strand 96, the boot clamp 108 may be wrapped with its interlock teeth profile 112 around the peripheral three axis interlock structure 124. Once the boot clamp 108 is tied down, the cable boot 104 becomes three dimensionally form fitting and elastically fixed with its peripheral three axis interlock structure 124 onto the interlock teeth profile 112.

Accordingly, the scope of the invention described in the figures and specification above is set forth by the following claims and their legal equivalent:

What is claimed is:

1. A cable boot comprising:
a. a cable through hole inside said cable boot;
b. a peripheral three axes interlock structure; and
wherein said peripheral three axes interlock structure encompasses said cable through hole.

2. The cable boot of claim 1, wherein said peripheral three axes interlock structure comprises a circumferential main groove and an axial rib.

3. The cable boot of claim 1, further comprising at least two body segments each comprising a mating face correspondingly shaped to an opposite one of said mating face, wherein said mating face extends substantially radial outward said cable through hole.

4. The cable strand of claim 3, wherein said mating faces comprise one of a snap stud and a snap hole via which that said at least two body segments are snapped together while said mating faces are in contact and while said cable through hole is circumferentially closed.

5. The cable boot of claim 3, further comprising a circumferential tie groove that is circumferentially extending across said mating face while said at least two body segments are snapped together.

6. The cable boot of claim 3, further comprising a circumferential tie guide hole that is aligned with said circumferential tie groove and that is substantially perpendicular with respect to said mating face.

7. The cable boot of claim 3, further comprising a flexible film joint rotationally free connecting said at least two body segments.

8. The cable boot of claim 7 comprising a monolithic structure.

9. The cable boot of claim 3, further comprising at least one of a seal ridge and a seal valley along an edge between a portion of said cable through hole and at least one of said mating faces.

10. The cable boot of claim 1, further comprising a radial seal rib extending substantially radial inward said cable through hole.

11. The cable boot of claim 1, being molded around a cable.

12. The cable boot of claim 1, further comprising:
a. an internal sealant distribution cavity extending radial outward said cable through hole and axially in between openings of said cable through hole; and
b. a peripheral sealant access port in communication with said internal sealant distribution cavity.

13. A cable clamp system comprising:
a. a cable boot comprising:
i. a cable through hole inside said cable boot; and
ii. a peripheral three axes interlock structure comprising a circumferential groove and an axial rib inside said circumferential groove;
wherein said peripheral three axes interlock structure encompasses said cable through hole;
b. a boot clamp comprising:
i. an interlock teeth profile matching said peripheral three axes interlock structure while said cable boot is clamped in said boot clamp;
ii. a clamp frame that is circumferentially connected to said interlock teeth profile;
iii. a clamp mounting interface; and
wherein said clamp frame comprises a clamping segmentation such that while said boot clamp is tied down via said clamp mounting interface, said interlock teeth profile is forced towards said peripheral three axes interlock structure via said clamp frame and a three axes form fitting interlock is established between said cable boot and said boot clamp.

14. The cable clamp system of claim 13, wherein said cable boot further comprises at least two body segments each comprising a mating face correspondingly shaped to an opposite one of said mating face, wherein said mating face extends substantially radial outward said cable through hole.

15. The cable clamp system of claim 14, wherein said mating faces comprise one of a snap stud and a snap hole via which that said at least two body segments are snapped together while said mating faces are in contact and while said cable through hole is circumferentially closed.

16. The cable clamp system of claim 14, wherein said cable boot further comprises a circumferential tie groove that is circumferentially extending across said mating face while said at least two body segments are snapped together.

17. The cable clamp system of claim 14, wherein said cable boot further comprises a circumferential tie guide hole that is substantially perpendicular with respect to said mating face.

18. The cable clamp system of claim 14, further comprising a flexible film joint rotationally free connecting said at least two body segments.

19. The cable clamp system of claim 18 comprising a monolithic structure.

20. The cable clamp system of claim 14, further comprising at least one of a seal ridge and a seal valley along an edge between a portion of said cable through hole and at least one of said mating faces.

21. The cable clamp system of claim 14, further comprising a boot tie wrapping around and tying together said at least two body segments.

22. The cable clamp system of claim 13, further comprising a radial seal rib extending substantially radial inward said cable through hole.

23. The cable clamp system of claim 13, being molded around a cable.

24. The cable clamp system of claim 13, wherein said cable boot further comprises:
a. an internal sealant distribution cavity extending radial outward said cable through hole and axially in between openings of said cable through hole; and
b. a peripheral sealant access port in communication with said internal sealant distribution cavity.

25. The cable clamp system of claim 13, wherein said interlock teeth profile comprises a vibration damping configuration.

26. A cable boot assembly tool comprising a separable boot cavity comprising:
a. an injection port;
b. cable alignment opening;
c. a separable boot cavity comprising a three axes interlock structure negative shape; and
wherein said separable boot cavity is shaped with respect to said cable alignment opening such that a substantially continuous cable boot shape including a three axes interlock structure is defined around a cable held in said cable alignment opening while said cable boot assembly tool is closed around said cable.

27. The cable boot assembly tool of claim 26, further comprising a hand operable cavity open and close mechanism.

28. The cable boot assembly tool of claim 27, wherein said hand operable cavity open and close mechanism further comprises a release able closing ratchet.

29. The cable boot assembly tool of claim 26, further comprising:
a. a molding material storage cavity;
b. a storage cavity heater; and
c. an injection mechanism.

30. The cable boot assembly tool of claim 29, wherein said molding material injection mechanism is manually operable.
